(19) United States
(12) Patent Application Publication
(10) Pub. No.: US 2006/0273180 A1
(43) Pub. Date: Dec. 7, 2006

(54) RFID label assembly

(75) Inventors: P. Charles Ammond, Grand Rapids, MI (US); Brian G. Parker, Alto, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Cascade Engineering, Inc.

(21) Appl. No.: 11/145,879

(22) Filed: Jun. 6, 2005

(51) Int. Cl. G06K 19/06

(52) U.S. Cl. 235/492

(57) ABSTRACT

An RFID label is bonded to the surface of a plastic container. The label includes a web of label stock having an antenna and an RFID chip on the reverse side of the label. The antenna and the chip are between the label and the container. The obverse side of the label is visible on the exterior of the container and includes printed material such as a barcode. A protective patch may overlie the RFID chip to protect the RFID chip from the molten polymer during the molding process.

### BACKGROUND OF THE INVENTION

The present invention relates generally to radio frequency identification (“RFID”) devices, and more particularly to an RFID label for attachment to a waste container.

RFID devices are well known for the advantages they provide in information storage. An RFID device can be attached to a variety of different products for storing unique information about that product. These devices generally include a scannable circuit board, or “RFID chip”, that may be programmed with unique identification information, and an antenna for transmitting the information to a reader. The devices do not need batteries, as they are powered by an electromagnetic field generated by the reader. The ability to write information to the chip from the reader allows the stored information to be updated only in an authorized manner.

RFID devices are useful in a variety of industries. For example, in the waste container industry, an RFID device may be attached to a waste container for storing information unique to that container, such as an identification number, and the time and date of manufacture. The stored information can be scanned by a reader located on the waste truck.

An example of an RFID device attached to a waste container is shown in U.S. Pat. No. 6,206,282. The RFID chip is embedded within the sidewall of a waste container during thermoforming of the container. Unfortunately, a number of difficulties arise in this arrangement. First, the molding process must be altered to accommodate for the insertion of a chip into the molten polymer during the molding process. This includes the insertion of special pins to hold the chip in place until the plastic has completely cured. Second, the area surrounding the chip must be cooled to avoid damaging the sensitive chip. Third, it may be difficult to read and transmit information to the chip because it is entirely embedded in plastic.

### SUMMARY OF THE INVENTION

The aforementioned problems are overcome by the present invention, wherein an RFID chip and antenna are attached to a label that is attached to the surface of a plastic waste container during molding of the container.

In a first embodiment, the present invention includes a web of label stock having a first surface and a second surface opposite the first surface. An antenna is printed on the second surface with conductive ink, and an RFID chip is attached to the antenna, for example with a conductive adhesive. The second surface of the label is molded to the surface of a container during molding of the container. Consequently, the RFID chip is between the label and the surface of the container, and the first surface is visible.

In a further refinement of the first embodiment, a barcode is printed on the first surface of the label stock, possibly with additional printed material such as a corporate logo. The barcode may correspond to the information stored on the RFID chip. One or both of the surfaces of the label may be coated with a protective UV coating. Consequently, the label can be RF scanned or optically scanned.

In a second embodiment, a protective patch is included between the RFID chip and the surface of the container to protect the RFID chip from the heat and physical forces received from the molten polymer during molding of the container. The antenna may be printed on either the second surface of the label stock, or on the protective patch.

The present invention provides an RFID assembly that is cost effective and relatively easy to manufacture because the labels can simply be attached to the exterior surface of a plastic container during molding of the container. In addition to providing RFID capabilities, the labels provide a location to include both aesthetic and functional printed information, such as a barcode or a corporate logo.

These and other objects, advantages, and features of the invention will be readily understood and appreciated by reference to the detailed description of the current embodiments and the drawings.

### BRIEF DESCRIPTION OF THE DRAWINGS

FIG. 1 is a perspective view of an RFID label attached to a waste container according to one embodiment of the present invention.

FIG. 2 is a front view of an RFID label according to one embodiment of the present invention.

FIG. 3 is a front perspective view of the RFID label.

FIG. 4 is a rear perspective view of the RFID label.

FIG. 5 is a rear perspective view of an RFID label including a protective patch.

FIG. 6 is an exploded view of another embodiment of the label wherein an antenna and RFID chip are attached to the protective patch.

FIG. 7 is a rear perspective view of the FIG. 6 embodiment showing the antenna and RFID chip in broken lines.

### DETAILED DESCRIPTION OF THE INVENTION

I. Overview

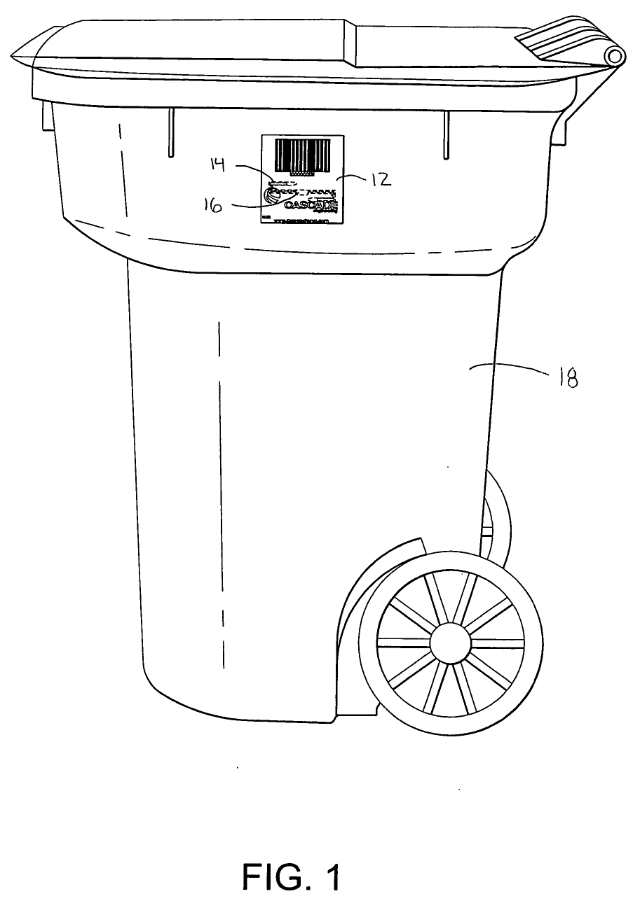

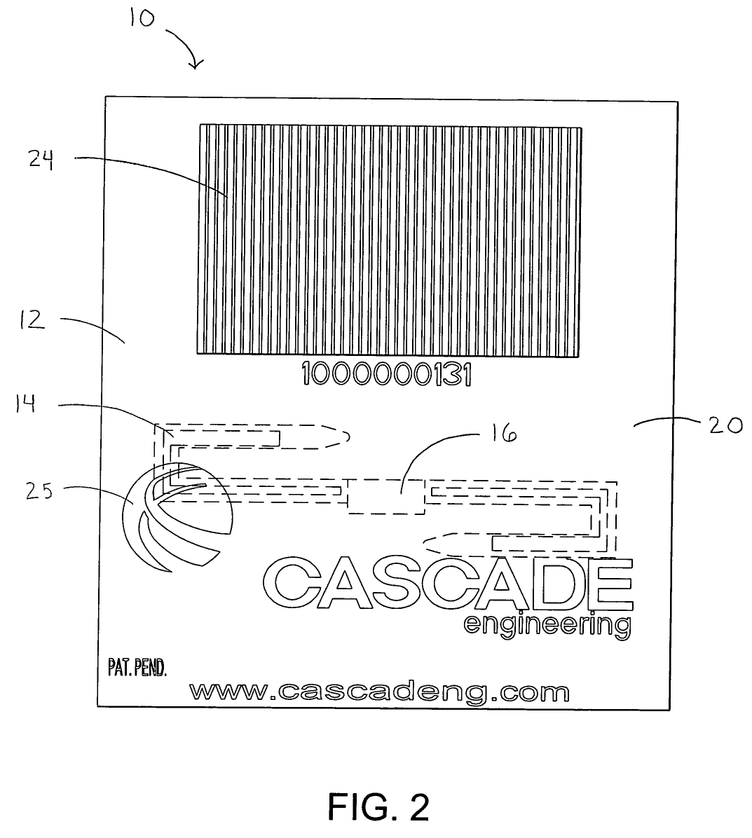

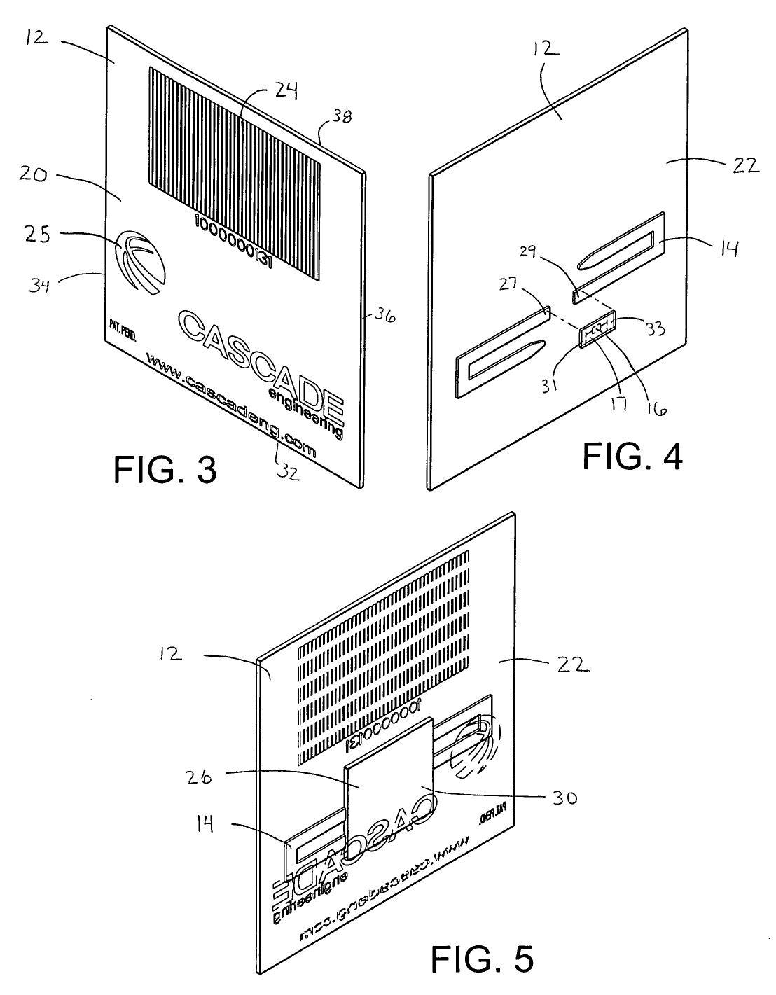

An RFID label according to the present invention is shown in FIG. 2 and generally designated 10. In general, the label includes a web of label stock 12, an antenna 14, and an RFID chip 16. Shown in FIG. 1, the web 12 is attached to the surface of a container 18, such that the antenna 14 and RFID chip 16 are between the label 10 and the surface of the container 18.

II. Structure

The web 12 is typically a section of sheet material that is cut to a desired size and shape. The web 12 is generally a polymeric sheet stock, such as 0.0065 in. thick polyethylene sheet stock. The web 12 includes a first surface 20 and a second surface 22. As shown, the first surface 20 includes printed information, such as a barcode 24. In addition to the barcode 24, the first surface may include a variety of other printed information, such as a corporate logo 25 or other marks of product identification. One or both of the surfaces may be coated with a variety of coatings. For instance, one or both surfaces may be coated with an ink primer coat before any printed information or other material is printed on the surface. In the illustrated embodiment, the first surface 20 is coated with a primer coat (not shown) before the printed information is applied. In a similar fashion, one or both of the surfaces may be Corona treated before the application of any ink. Corona treatment is a known process wherein the surface energy of the web 12 is altered, but the material properties stay the same. This treatment allows the surface to receive ink, such as the printed antenna 14 described below, while still allowing the polyethylene surface 22 to attach to the injection molded surface of a container. In the illustrated embodiment, only the second surface 22 is Corona treated. In addition, a protective UV coating (not shown) may be applied to one or both surfaces to prolong the life of the label 10. In the illustrated embodiment, a UV coating is applied to the first surface 20.

The antenna 14 is conventional, and is typically printed on the second surface 22 of the web 12 with a conductive ink, such as a silver based ink manufactured by Precisia, Inc. As described above, the second surface 22 is typically Corona treated prior to the application of the antenna 14 so that the ink antenna attaches to the surface 22, and so that the surface 22 is still able to attach to another plastic surface, such as the surface of an injection molded container. The antenna 14 may extend along the second surface 22 of the web 12 in a variety of desired patterns; however, the size and shape are generally chosen to maximize the transmission distance of the chip. Shown in FIG. 4, the antenna is printed in two halves that terminate proximate to each other at a pair of electrical contact points 27, 29 for connection to the RFID chip 16.

The RFID chip 16 is also conventional, and therefore will not be described in great detail. In short, the chip 16 is a programmable semiconductor, such as an EPC Class 1 915 MHz chip manufactured by Alien Technology. As shown in FIG. 4, the chip 16 may be attached to a plastic substrate 17, known in the industry as a strap, that includes a pair of electrically conductive pads 31, 33 for connecting the chip to the antenna 14. As shown in FIG. 4, the strap is attached to the antenna 14 such that the electric leads 27, 29 on the antenna 14 are in electrical connection with the pads 31, 33 on the strap 17. In one embodiment, the strap is attached to the antenna 14 with a conductive adhesive (not shown). In another embodiment, the electrical connections may be soldered together.

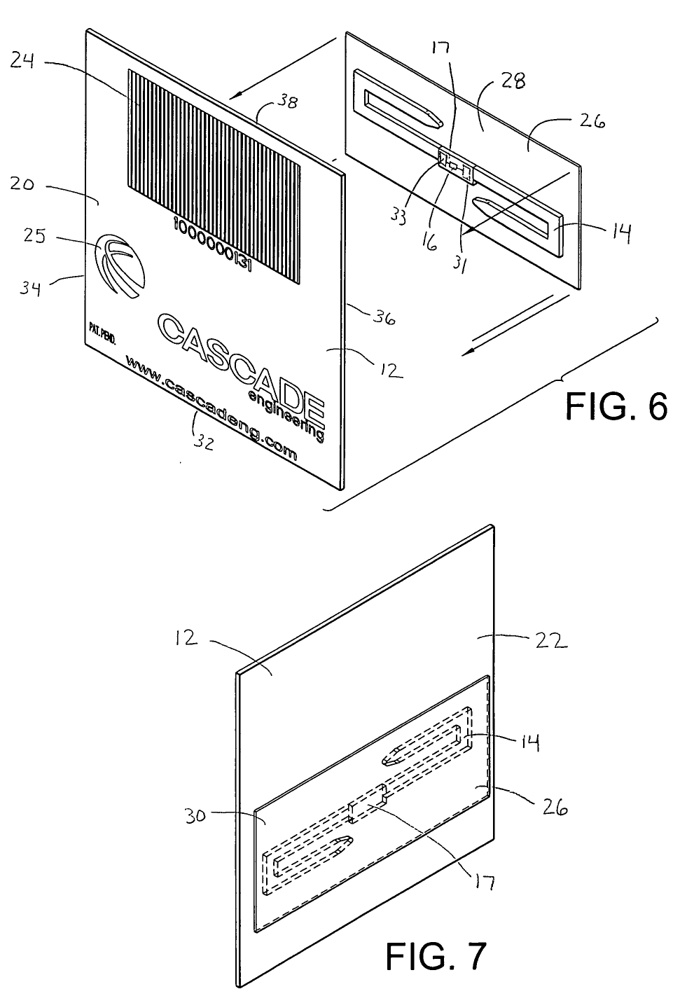

In one embodiment, shown in FIGS. 5-7, a protective patch 26 may be attached to the second surface 22 of the web 12. The protective patch 26 may be comprised of a variety of materials. In one embodiment, the protective patch 26 is comprised of the same label stock as the web 12. The protective patch includes a first surface 28 and a second surface 30. The first surface 28 of the patch 26 is attached to the second surface 22 of the web 12, for instance, with an adhesive, such that it covers at least the strap 17. As shown in FIG. 5, the protective patch covers the strap 17, the RFID chip 16, and a portion of the antenna 14. In another embodiment, shown in FIGS. 6 and 7, the antenna 14 may be printed on the first surface 28 of the protective patch 26, and the strap 17 attached to the antenna 14 on the patch 26 such that the electrical pads 31, 33 connect to the leads 27, 29 on the antenna 14. In this embodiment, the patch 26, antenna 14 and chip 16 are attached as a unit to the second surface 22 of the web 12. As with the web 12, one or both surfaces of the protective patch 26 may be coated or treated with one or more coatings.

The container 18 is thermoformed plastic, typically formed by molding, such as injection molding, roto molding, vacuum molding or blow molding. In the illustrated embodiment, the label 10 is shown attached to a conventional waste container 18; however, the label 10 may alternatively be attached to a wide variety of injection molded products. The label 10 is generally attached to the container by one of two methods. In a first method, a pressure sensitive adhesive is applied to the second surface 22 of the label and the label 10 is then adhered to the container 18. In a second method, the label is “in-molded” 18 during the molding process, such that the second surface 22 is bonded to a surface of the container 18. In-molding is a process in which the label is placed in the mold before the plastic material is injected or otherwise placed into the mold. With suitable material selection, the label physically bonds with the injected plastic material. Alternatively, a heat-activated adhesive may be applied to the reverse side of the label, in which case the adhesive would be activated by the injected plastic. Appropriate in-molding techniques are known to those skilled in the art. As the plastic cools and cures, the second surface 22 of the label 10 remains attached to the surface of the container 18, with the antenna 14 and RFID chip 16 disposed between the label 10 and container 18.

III. Manufacture

Manufacture of the label 10 includes the steps of 1) preparing the surfaces of the web 12, 2) applying printed material to the surfaces of the web 12, 3) attaching an RFID chip to the web 12, and 4) attaching the web 12 to a plastic structure.

Preparing the surfaces of the web 12 typically involves applying a primer coat to the first surface 20 and Corona treating the second surface 22. Alternative coatings are also known. The desired printed information, such as a barcode 24 and corporate logo 25, are applied to the front surface 20, and the antenna 14 is printed on the second surface 22. Conventional printers are used for both applications. As described above, in an alternative embodiment, the antenna may be printed on a separate protective patch 26.

The strap 17 is then attached to the antenna 14. This is typically done by applying a conductive adhesive to either the strap 17 or the antenna 14 and then pressing the two together with the electrical contacts aligned. In the embodiment including a protective patch 26, wherein the antenna 14 is printed on the protective patch 26, the chip 26 may be attached to the protective patch 26. The protective patch 26 is adhered to the second surface 22 of the web 12 with a conventional adhesive.

The label 10 is then attached to the substrate of a plastic structure, such as the waste container 18, by a pressure sensitive adhesive or during the injection molding process. The pressure sensitive adhesive method involves applying the adhesive to the second surface 22 of the label 10 and placing the label 10 on the container 18. In the in-mold method, one or both surfaces of the label may be provided with a static charge so it will stick to the surface of a mold. The label 10 is placed in the mold with the second surface 22 facing the mold cavity, and the first surface 20 bearing against the mold. The molten plastic is injected into the mold to contact the second surface 22 and to encapsulate the top 38, bottom 32, and side edges 34, 36 of the label 10. The second surface 20 remains exposed. As the plastic cures, the RFID enabled label is attached to the plastic structure.

The above description is that of the current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. An RFID assembly, comprising:
a web of label stock having a first surface and a second surface opposite said first surface;
printed material on said first surface;
an antenna on said second surface;
an RFID on said second surface and in electrical connection with said antenna; and
a molded plastic substrate, said antenna and said RFID chip disposed between said web and said substrate.

2. The label of claim 1 wherein said printed material on said first surface includes a barcode.

3. (canceled)

4. The label of claim 1 wherein said RFID chip is attached to a plastic strap, said strap including electrical leads, said electrical leads attached to said antenna and said RFID chip with a conductive adhesive.

5. An RFID enabled waste container comprising:
a plastic container;
a web of label stock having a first surface and a second surface opposite said first surface;
an antenna on said second surface; and
an RFID chip operatively connected to said antenna, said first surface being visible on the exterior of said plastic container, said RFID chip between said web and said plastic container.

6. The container of claim 5 further comprising a protective patch between said plastic container and said RFID chip.

7. The container of claim 5 wherein said label is molded to said plastic container such that said plastic container encapsulates said second surface, a top edge, a bottom edge, and first and second side edges of said web.

8. The container of claim 5 wherein said antenna is printed on said second surface with conductive ink.

9. The container of claim 5 wherein said first surface of said container includes a barcode, said RFID chip containing identification information corresponding to said barcode.

10. (canceled)

11. An RFID assembly, comprising:
a web of label stock;
a protective patch;
an RFID chip between said web and said protective patch;
an antenna at least partially between said web and said protective patch, said antenna in electrical connection with said RFID chip; and
a molded plastic product, at least one of said web and said protective patch bonded to said plastic product such that said protective patch is disposed between said web and said plastic product.

12. The RFID label of claim 11 wherein said web includes a barcode printed on said web opposite said RFID chip.

13. The RFID label of claim 11 wherein said RFID chip is adhered to said antenna with a conductive adhesive.

14. The RFID label of claim 11 wherein said antenna is printed with a conductive ink.

15. (canceled)

16. A method for manufacturing a plastic container comprising:
providing an antenna on the first surface of a web of label stock;
providing an RFID chip on the first surface in electrical connection with the antenna; and
in-molding the web of label stock to the plastic container so the antenna and RFID are between the web and the container.

17. The method of claim 16 further comprising printing a barcode on a second surface of the web opposite the first surface.

18. The method of claim 16 further comprising attaching a protective patch over the RFID chip before in-molding the web to the container.

20. The method of claim 16 wherein said in-molding step includes encapsulating the first surface, a top edge, a bottom edge, and first and second side edges of the web.

21. A method for forming an RFID assembly, comprising:
providing an antenna at least partially between a web of label stock and a protective patch;
providing an RFID chip between the web of label stock and the patch, the RFID chip in electrical connection with the antenna; and
in-molding the web of label stock, the protective patch, the antenna, and the RFID chip to a plastic container, the protective patch between the web and the container.

22. The method of claim 21 further comprising printing information on a surface of the web opposite the container.

23. The method of claim 21 wherein product identification information is stored on the RFID chip, and wherein the printed information is a barcode that corresponds to the product identification information.
